(19) United States
(12) Patent Application Publication
(10) Pub. No.: US 2026/0217207 A1
(43) Pub. Date: Jul. 30, 2026

(54) ENERGY CAPACITY SYSTEM FOR A VEHICLE

(71) Applicant: GM Global Technology Operations LLC, Detroit, MI (US)

(72) Inventors: Ahmed F. Al Alawy, Canton, MI (US); Scott Thomas Droste, West Bloomfield, MI (US)

(73) Assignee: GM Global Technology Operations LLC, Detroit, MI (US)

(21) Appl. No.: 19/036,384

(22) Filed: Jan. 24, 2025

(51) Int. Cl. B60R 16/03

(52) U.S. Cl. CPC B60R 16/0315

(57) ABSTRACT

A computer-implemented method when executed by data processing hardware causes the data processing hardware to perform operations. The operations include receiving, at a centralized electronic control unit (ECU), an energy request from a first controller of a plurality of controllers, generating, via a capacity algorithm of the centralized ECU, a capacity query, issuing, via the centralized ECU, the capacity query to one or more of the plurality of controllers, and receiving, at the centralized ECU, one or more donation responses from one or more of the plurality of controllers. The operations also include aggregating the one or more donation responses, adjusting, via the capacity algorithm, an energy capacity of the first controller, and determining, via the capacity algorithm, a fulfillment status of the first controller based on the adjusted energy capacity.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an energy capacity system for a vehicle.

Modern vehicles are frequently equipped with multiple electronic control units (ECUs) that consume varying amounts of energy even when the vehicle's ignition is turned off. For instance, these ECUs rely on a reserve battery to continue functioning for a predetermined period after the ignition is inactive. Depending on the circumstances, the ECUs can remain operational for several days or even weeks before the reserve battery is depleted. Once the reserve battery is exhausted, the ECU loses power, rendering the user unable to access the features controlled by that ECU. Therefore, there is a need for an enhanced reserve battery system that can provide additional energy resources to ECUs, preventing them from exhausting their allocated energy capacity.

### SUMMARY

In some aspects, a computer-implemented method when executed by data processing hardware causes the data processing hardware to perform operations. The operations include receiving, at a centralized electronic control unit (ECU), an energy request from a first controller of a plurality of controllers, generating, via a capacity algorithm of the centralized ECU, a capacity query, issuing, via the centralized ECU, the capacity query to one or more of the plurality of controllers, and receiving, at the centralized ECU, one or more donation responses from one or more of the plurality of controllers. The operations also include aggregating the one or more donation responses, adjusting, via the capacity algorithm, an energy capacity of the first controller, and determining, via the capacity algorithm, a fulfillment status of the first controller based on the adjusted energy capacity.

In some examples, the energy request may include a capacity depletion of the first controller. The operations may include assigning, via the capacity algorithm, an updated operation mode to the first controller and limiting, via the capacity algorithm, an operative function of the first controller based on the updated operation mode. In some instances, receiving the energy request may include receiving a plurality of energy requests from the plurality of controllers. The operations may also include assigning, via the capacity algorithm, a priority ranking to each request of the plurality of energy requests. At least one of the plurality of energy requests may receive a first priority of the priority ranking.

Optionally, generating the capacity query may include determining the assigned priority ranking of the received energy request and issuing the capacity query for a controller of the plurality of controllers having the first priority of the assigned priority ranking. The operations may further include identifying one or more controllers of the plurality of controllers that are configured with a high energy capacity. In some instances, issuing the capacity query may include issuing the capacity query to the one or more controllers of the plurality of controllers that are configured with the high energy capacity.

In other aspects, an energy capacity system for a vehicle includes a plurality of controllers and a centralized electronic control unit (ECU) communicatively coupled with each of the plurality of controllers. Each controller of the plurality of controllers includes an energy capacity. The centralized ECU includes data processing hardware and memory hardware in communication with the data processing hardware. The memory hardware stores instructions that when executed on the data processing hardware cause the data processing hardware to perform operations. The operations include receiving an energy request from a first controller of the plurality of controllers, receiving one or more donation responses from one or more of the plurality of controllers, aggregating the one or more donation responses, and adjusting, via a capacity algorithm of the centralized ECU, an energy capacity of the first controller.

In some examples, the operations may include assigning, via the capacity algorithm, an updated operation mode of the first controller and limiting, via the capacity algorithm, an operative function of the first controller based on the updated operation mode. Optionally, receiving the energy request may include receiving a plurality of energy requests from the plurality of controllers. The operations may further include generating a priority matrix including a plurality of priority rankings, the plurality of priority rankings including a first priority and assigning, via the capacity algorithm, a priority ranking from the priority matrix to each request of the plurality of energy requests, at least one of the plurality of energy requests receiving the first priority.

In some instances, generating the capacity query may include determining the assigned priority ranking of the received energy request and issuing a capacity query for a controller of the plurality of controllers having the first priority of the assigned priority ranking. The operations may also include identifying one or more controllers of the plurality of controllers that are configured with a high energy capacity. The operations may further include generating, via a capacity algorithm of the centralized ECU, a capacity query. Optionally, issuing the capacity query may include issuing the capacity query to the one or more controllers of the plurality of controllers that are configured with the high energy capacity. The operations may also include issuing, via the centralized ECU, the capacity query to one or more of the plurality of controllers.

In further aspects, an energy capacity system for a vehicle includes a plurality of controllers and a centralized electronic control unit (ECU) communicatively coupled with each of the plurality of controllers. Each controller of the plurality of controllers including an energy capacity. The centralized ECU includes an energy bank, data processing hardware, and memory hardware in communication with the data processing hardware. The memory hardware stores instructions that when executed on the data processing hardware cause the data processing hardware to perform operations. The operations include receiving an energy request from a first controller of the plurality of controllers, providing, from the energy bank, energy resources to the first controller, and adjusting, via a capacity algorithm, the energy capacity of the first controller.

In some examples, the operations may include assigning, via the capacity algorithm, an updated energy capacity to the first controller and limiting, via the capacity algorithm, an operative function of the first controller based on the updated energy capacity. Optionally, receiving the energy request may include receiving a plurality of energy requests from the plurality of controllers, assigning, via the capacity algorithm, a priority ranking to each request of the plurality of energy requests, at least one of the plurality of energy requests receiving a first priority of the priority ranking, and generating the capacity query includes determining the assigned priority ranking of the received energy request and issuing the capacity query for a controller of the plurality of controllers having the first priority of the assigned priority ranking.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with an energy capacity system according to the present disclosure;

FIG. 2 is an exemplary block diagram of an energy capacity system according to the present disclosure;

FIG. 3 is a schematic diagram of an energy capacity system according to the present disclosure with a centralized electronic control unit (ECU) in communication with a depleted controller and a plurality of donation controllers;

FIG. 4 is an example flow diagram of an energy capacity system according to the present disclosure; and

FIG. 5 is an exemplary method of operation of an energy capacity system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

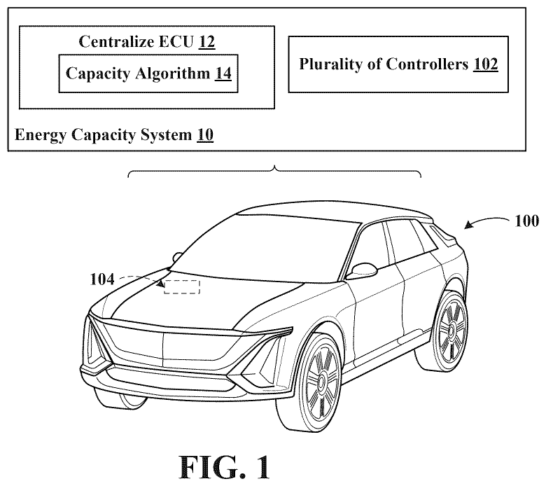

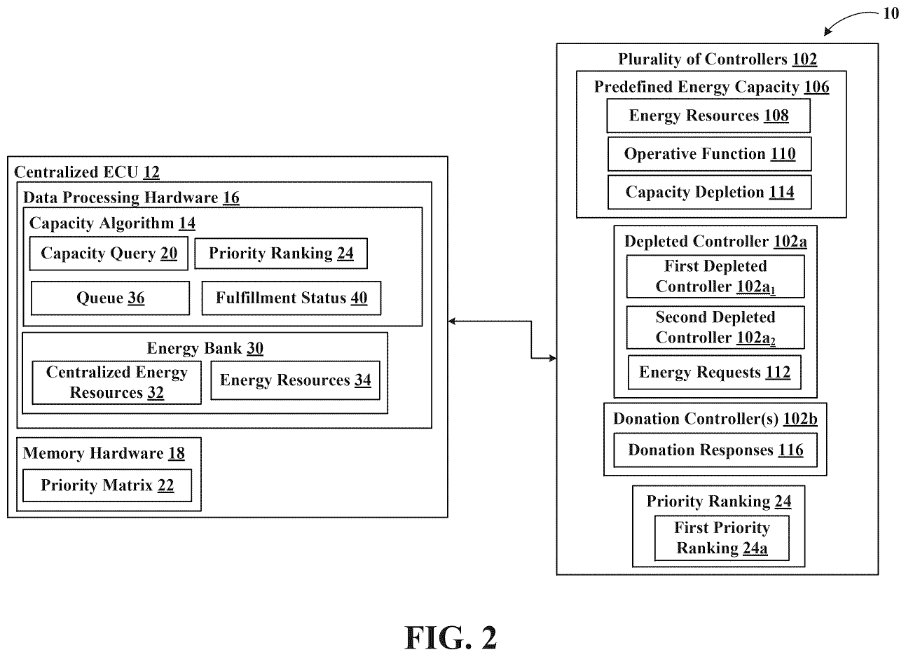

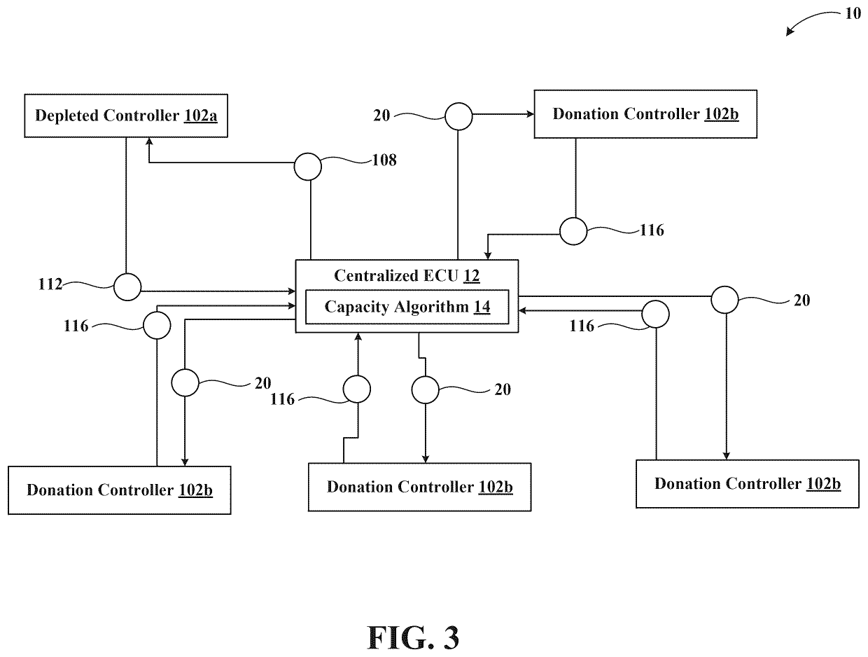

Referring to FIGS. 1-3, an energy capacity system 10 for a vehicle 100 includes a centralized electronic control unit (ECU) 12 configured to execute a capacity algorithm 14. The centralized ECU 12 is communicatively coupled with a plurality of controllers 102 of the vehicle 100. The plurality of controllers 102 are configured to execute various operative functions for the vehicle 100 that may be controlled or otherwise utilized by a user when an ignition 104 of the vehicle 100 is inactive. For example, each of the plurality of controllers 102 is configured with a predefined energy capacity 106 that may be monitored by the centralized ECU 12. The predefined energy capacity 106 is configured to provide sufficient energy resources 108 to the respective controller 102 to execute one or more operative functions 110 of the controller 102, described in more detail below.

The plurality of controllers 102 may be configured to execute a variety of operative functions 110 including, but not limited to, window controls, lighting, user interface systems, and communication services. The predefined energy capacity 106 of each of the controllers 102 is configured to provide sufficient energy resources 108 to power the operative functions 110 of each controller 102 for a predetermined period of time. For example, the plurality of controllers 102 may be configured to execute the operative functions 110 for one to two weeks before expending the energy sources 108. The predetermined period of time for the operative functions 110 is reflected by the predefined energy capacity 106 of each controller 102. In some instances, a user may exhaust the energy resources 108 prior to the predetermined period of time, such that the predefined energy capacity 106 is exhausted. The energy capacity system 10 is configured to monitor the energy resources 108 across the plurality of controllers 102 and utilize the centralized ECU 12 to interchange the energy resources 108 between controllers 102, as described in more detail below.

Referring still to FIGS. 1-3, the centralized ECU 12 includes data processing hardware 16 and memory hardware 18 in communication with the data processing hardware 16. The memory hardware 18 stores instructions that when executed on the data processing hardware cause the data processing hardware to perform operations, described herein. The data processing hardware 16 is configured to execute the capacity algorithm 14 in response to one or more energy requests 112 from one or more of the plurality of controllers 102. The energy requests 112 include a capacity depletion 112a of a depleted controller 102a (i.e., a first controller 102a) of the plurality of controllers 102. For example, the depleted controller 102a may issue an energy request 112 in response to a capacity depletion 114 of the predefined energy capacity 106. The centralized ECU 12 is configured to receive the energy request 112 at the capacity algorithm 14 and, in response, may generate a capacity query 20.

The capacity query 20 is configured to reflect the capacity depletion 112a, such that the capacity query 20 may specify an energy value 20a requested by the depleted controller 102a. The capacity query 20 is configured to identify one or more of the controllers 102 that may have an energy resource 108 available for use by other controllers 102. For example, the centralized ECU 12 may generate the capacity query 20 in response to the energy request 112 from the first controller 102a and may transmit the capacity query 20 to one or more donation controllers 102b (i.e., the remaining plurality of controllers 102). The donation controllers 102b provide the centralized ECU 12 with a donation response 116 indicating whether the one or more donation controllers 102b have additional or spare energy resources 108. The donation response 116 may include a value associated with the energy resources 108 remaining in the predefined energy capacity 106 for each of the controllers 102b.

In some instances, the donation response 116 may indicate that a donation controller 102b has minimal energy resources 108 available. The centralized ECU 12 is configured to compare the donation responses 116 from each of the donation controllers 102b to identify which donation controller 102b from which to draw the energy resources 108 to fulfill the energy request 112. The centralized ECU 12 may also aggregate the donation responses 116 and selectively draw energy resources 108 from one or more of the donation controllers 102b. The centralized ECU 12 may be communicatively coupled with each of the plurality of controllers 102 via Bluetooth®, Bluetooth® low energy, or any other low energy communication technology. Thus, the centralized ECU 12 may draw energy resources 108 from the donation controllers 102b without depleting the predefined energy capacities 106 of the respective donation controllers 102b. The centralized ECU 12 may identify, upon receiving the donation responses 116, which of the donation controllers 102b are configured with a high energy capacity 106a.

A high energy capacity 106a is defined as an energy capacity 106 that exceeds the likely use of the energy resources 108 for a respective controller 102. For example, a controller 102 may have a predefined energy capacity 106 that is equal to an energy capacity 106 of the other controllers 102 but remains inactive when the ignition 104 is inactive. Thus, the centralized ECU 12 may categorize the exemplary controller 102 as having a high energy capacity 106a due to the available energy resources 108. In other instances, a respective controller 102 may be configured with a predefined energy capacity 106 that is greater than the predefined energy capacities 106 of the other controllers 102, such that the volume of energy resources 108 is greater than those of the other controllers 102. The centralized ECU 12 may be configured to target the controller(s) 102 having the high energy capacity 106a. For example, the capacity query 20 may be issued to the controller(s) 102 with the high energy capacity 106a.

In other instances, the centralized ECU 12 may receive a plurality of energy requests 112 from one or more of the controllers 102. For example, a first depleted controller 102a1 and a second depleted controller 102a2 may each issue energy requests 112 to the centralized ECU 12. In response, the centralized ECU 12 may include a priority matrix 22 stored in the memory hardware 18 that is configured with a priority ranking 24 for each of the controllers 102. Each of the controllers 102 is also configured with the priority ranking 24, which is provided to the centralized ECU 12 with the energy request 112. Upon receiving multiple energy requests 112, the centralized ECU 12 utilizes the priority matrix 22 to compare the priority rankings 24 received with each energy request 112. The priority matrix 22 results in at least one of the plurality of energy requests 112 receiving a first priority 24a, such that the centralized ECU 12 may prioritize the depleted controller 102a having the first priority 24a.

For example, the capacity algorithm 14 is configured to determine the assigned priority ranking 24 of the energy requests 112 prior to generating the capacity query 20. Once the priority ranking 24 is determined, the capacity algorithm 14 issues the capacity query 20 for the depleted controller 102a having the first priority 24a. In the example mentioned above, the first depleted controller 102a1 may have a higher priority ranking 24 as compared to the second depleted controller 102a2. The priority ranking 24 may be determined based on the operative functions 110 of the associated depleted controller 102a. If the first depleted controller 102a1 has operative functions 110 associated with safety functions, such as communication, and the second depleted controller 102a2 has operative functions 110 of interior light control, then the capacity algorithm 14 will assign the first priority ranking 24a to the first depleted controller 102a1.

In some instances, each of the plurality of controllers 102 may be preprogrammed with the priority ranking 24, such that the priority matrix 22 may be embedded in the centralized ECU 12. In such examples, the centralized ECU 12 utilizes the priority matrix 22 in a similar manner to that described above and is able to use the priority matrix 22 as a lookup or reference matrix. For example, the centralized ECU 12 may receive the energy requests 112 from the depleted controllers 102a and utilize the priority matrix 22 to identify the associated priority ranking 24 from the priority matrix 22. The priority rankings 24 are generally determined based on need. For example, operative functions 110 concerning safety and security would have a higher priority ranking 24 as compared to operative functions 110 concerning interior light or climate controls.

With further reference to FIGS. 1-3, the centralized ECU 12 may also adjust the energy capacity 106 for the depleted controller 102a, via the capacity algorithm 14, after receiving the donation response(s) 116. The adjusted energy capacity 106 provides the depleted controller 102a with the ability to accept and utilize the additional energy resources 108. The centralized ECU 12 is configured to receive the energy resources 108 from the donation controller(s) 102b and distribute the donated energy resources 108 to the depleted controller 102a. The capacity algorithm 14 is also configured to assign an updated operation mode 110a to the depleted controller 102a. The updated operation mode 110a is configured to limit the operative function 110 of the depleted controller 102a based on the updated operation mode 110a. For example, the updated operation mode 110a may restrict the operative function 110 to prioritize safety and security functions that may be associated with the depleted controller 102a. In other instances, the updated operation mode 110a may result in limiting the operative functions 110 to critical or primary functions only of the depleted controller 102a.

Referring still to FIGS. 1-3, in some examples, the centralized ECU 12 is configured with an energy bank 30. The energy bank 30 may be a surplus of centralized energy resources 32 for the centralized ECU 12 that may be redirected to the depleted controller 102a in response to the energy request 112. The capacity algorithm 14 may receive the energy request 112 from the depleted controller(s) 102a and may redirect a portion of the centralized energy resources 32 from the energy bank 30 to the depleted controller(s) 102a. In this configuration, the capacity algorithm 14 does not issue the capacity query 20, as the energy bank 30 is utilized to fulfill the energy request(s) 112. The centralized ECU 12 is configured with separate energy resources 34 that are utilized to operate the centralized ECU 12, such that the centralized energy resources 32 stored in the energy bank 30 are reserved for fulfilling energy request(s) 112.

Regardless of whether the centralized ECU 12 utilizes one of the donation responses 116 or the energy bank 30, the centralized ECU 12 updates the depleted controller 102a with a fulfillment status 40. The fulfillment status 40 is defined by the energy request 112 being satisfied. For example, the depleted controller 102a may receive energy resources 108 from the centralized ECU 12 corresponding to the energy request 112. The fulfillment status 40 provides the centralized ECU 12 with a metric to monitor when energy requests 112 have been fulfilled. Once the fulfillment status 40 is met, the centralized ECU 12 may remove the energy request 112 from a queue 36 of the capacity algorithm 14.

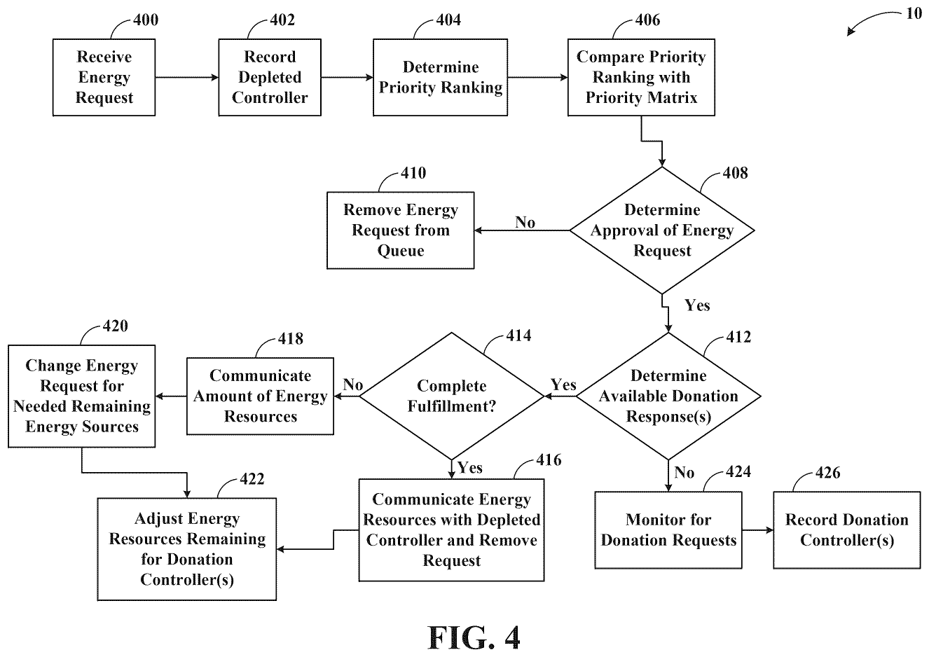

Referring now to FIG. 4, an example flow diagram is illustrated reflecting the energy capacity system 10 including the centralized ECU 12 and each of the controllers 102. At 400, the centralized ECU 12 receives an energy request 112 and, at 402, records the depleted controller 102a including the energy request 112. The capacity algorithm 14 determines, at 404 the priority ranking 24 of the depleted controller 102 a. At 406, the capacity algorithm 14 compares the priority ranking 24 of the depleted controller 102a with the priority matrix 22 and determines, at 408, whether to approve the energy request 112 based on the priority ranking 24. If the centralized ECU 12 denies the energy request 112, then the capacity algorithm 14 removes, at 410, the energy request 112 from a queue. If the centralized ECU 12 grants the energy request 112, then the capacity algorithm 14 determines, at 412, whether there are donation responses 116 available.

If there are donation responses 116 available, then the capacity algorithm determines, at 414, whether to complete fulfillment of the energy request 112. If the energy request 112 is fulfilled, then the centralized ECU 12 communicates, at 416, with the depleted controller 102a the amount of energy resources 108 requested in the energy request 112 and removes the energy request 112 from the queue. If the energy request 112 cannot be completed, the centralized ECU 12 communicates, at 418, the amount of energy resources 108 that may be provided (i.e., a partial amount or none) and changes, at 420, the energy request 112 to reflect the needed remaining energy resources 108 that remained unfulfilled. The centralized ECU 12 then adjusts, at 422, the amount of energy resources 108 remaining for the associated donation controller 102b.

If there are no donation responses 116 available, then the capacity algorithm 14 returns to monitor, at 424, whether any donation responses 116 are received. If donation responses 116 are received, then the capacity algorithm 14 records, at 426, the associated donation controller 102b along with the amount of donated energy resources 108.

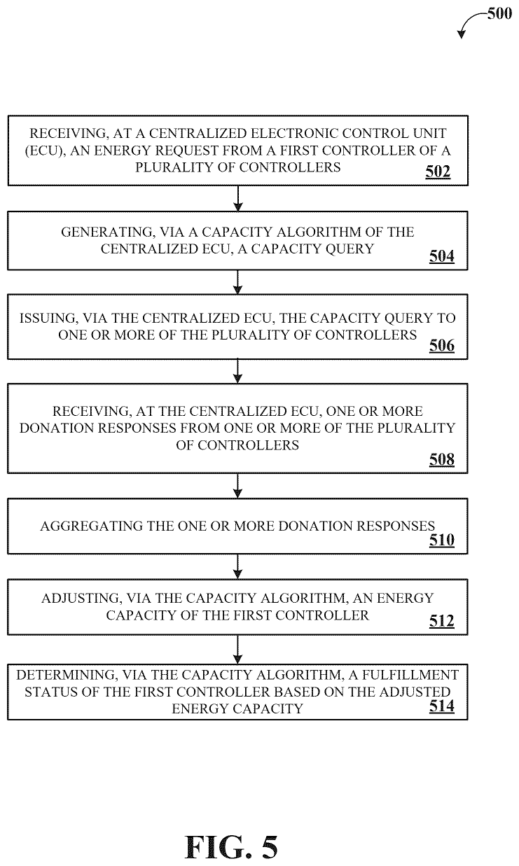

With reference now to FIG. 5, an exemplary method 500 of operation of the energy capacity system 10 is illustrated. At 502, the centralized ECU 12 receives an energy request 112 from a first, depleted controller 102a of a plurality of controllers 102. The capacity algorithm 14 of the centralized ECU 12 generates, at 504, a capacity query 20 and issues, at 506, the capacity query 20 to one or more of the plurality of controllers 102. The centralized ECU 12 receives, at 508, one or more donation responses 116 from one or more of the plurality of controllers 102. The plurality of controllers 102 that send the donation responses 116 are the donation controllers 102 b. The centralized ECU 12 aggregates, at 510, the one or more donation responses 116 and adjusts, at 512, via the capacity algorithm 14, an energy capacity 106 of the first, depleted controller 102 a. The capacity algorithm 14 determines, at 514, a fulfillment status 40 of the first controller 102a based on the adjusted energy capacity 106.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at a centralized electronic control unit (ECU), an energy request from a first controller of a plurality of controllers;
generating, via a capacity algorithm of the centralized ECU, a capacity query;
issuing, via the centralized ECU, the capacity query to one or more of the plurality of controllers;
receiving, at the centralized ECU, one or more donation responses from one or more of the plurality of controllers;
aggregating the one or more donation responses;
adjusting, via the capacity algorithm, an energy capacity of the first controller; and
determining, via the capacity algorithm, a fulfillment status of the first controller based on the adjusted energy capacity.

2. The method of claim 1, wherein the energy request includes a capacity depletion of the first controller.

3. The method of claim 1, further including assigning, via the capacity algorithm, an updated operation mode to the first controller and limiting, via the capacity algorithm, an operative function of the first controller based on the updated operation mode.

4. The method of claim 1, wherein receiving the energy request includes receiving a plurality of energy requests from the plurality of controllers.

5. The method of claim 4, further including assigning, via the capacity algorithm, a priority ranking to each request of the plurality of energy requests, at least one of the plurality of energy requests receiving a first priority of the priority ranking.

6. The method of claim 5, wherein generating the capacity query includes determining the assigned priority ranking of the received energy request and issuing the capacity query for a controller of the plurality of controllers having the first priority of the assigned priority ranking.

7. The method of claim 1, further including identifying one or more controllers of the plurality of controllers that are configured with a high energy capacity.

8. The method of claim 7, wherein issuing the capacity query includes issuing the capacity query to the one or more controllers of the plurality of controllers that are configured with the high energy capacity.

9. An energy capacity system for a vehicle comprising:
a plurality of controllers, each controller of the plurality of controllers including an energy capacity; and
a centralized electronic control unit (ECU) communicatively coupled with each of the plurality of controllers, the centralized ECU including:
data processing hardware; and
memory hardware in communication with the data processing hardware, the memory hardware storing instructions that when executed on the data processing hardware cause the data processing hardware to perform operations comprising:
receiving an energy request from a first controller of the plurality of controllers;
receiving one or more donation responses from one or more of the plurality of controllers;
aggregating the one or more donation responses; and
adjusting, via a capacity algorithm of the centralized ECU, an energy capacity of the first controller.

10. The energy capacity system of claim 9, further including assigning, via the capacity algorithm, an updated operation mode of the first controller and limiting, via the capacity algorithm, an operative function of the first controller based on the updated operation mode.

11. The energy capacity system of claim 9, wherein receiving the energy request includes receiving a plurality of energy requests from the plurality of controllers.

12. The energy capacity system of claim 11, further including:
generating a priority matrix including a plurality of priority rankings, the plurality of priority rankings including a first priority; and
assigning, via the capacity algorithm, a priority ranking from the priority matrix to each request of the plurality of energy requests, at least one of the plurality of energy requests receiving the first priority.

13. The energy capacity system of claim 12, wherein generating the capacity query includes determining the assigned priority ranking of the received energy request and issuing a capacity query for a controller of the plurality of controllers having the first priority of the assigned priority ranking.

14. The energy capacity system of claim 9, further including identifying one or more controllers of the plurality of controllers that are configured with a high energy capacity.

15. The energy capacity system of claim 14, further including generating, via a capacity algorithm of the centralized ECU, a capacity query.

16. The energy capacity system of claim 15, wherein issuing the capacity query includes issuing the capacity query to the one or more controllers of the plurality of controllers that are configured with the high energy capacity.

17. The energy capacity system of claim 16, further including issuing, via the centralized ECU, the capacity query to one or more of the plurality of controllers.

18. An energy capacity system for a vehicle comprising:
a plurality of controllers, each controller of the plurality of controllers including an energy capacity; and
a centralized electronic control unit (ECU) communicatively coupled with each of the plurality of controllers, the centralized ECU including:
an energy bank;
data processing hardware; and
memory hardware in communication with the data processing hardware, the memory hardware storing instructions that when executed on the data processing hardware cause the data processing hardware to perform operations comprising:
receiving an energy request from a first controller of the plurality of controllers;
providing, from the energy bank, energy resources to the first controller; and
adjusting, via a capacity algorithm, the energy capacity of the first controller.

19. The energy capacity system of claim 18, further including assigning, via the capacity algorithm, an updated energy capacity to the first controller and limiting, via the capacity algorithm, an operative function of the first controller based on the updated energy capacity.

20. The energy capacity system of claim 18, wherein receiving the energy request includes:
receiving a plurality of energy requests from the plurality of controllers;
assigning, via the capacity algorithm, a priority ranking to each request of the plurality of energy requests, at least one of the plurality of energy requests receiving a first priority of the priority ranking; and
generating the capacity query includes determining the assigned priority ranking of the received energy request and issuing the capacity query for a controller of the plurality of controllers having the first priority of the assigned priority ranking.
